(19) United States
(12) Patent Application Publication
(10) Pub. No.: US 2014/0358618 A1
(43) Pub. Date: Dec. 4, 2014

(54) Method and System for Addition of New Fiscal Year Through Single Click

(71) Applicants: Jack Yu, Cupertino, CA (US); Sachin Chaudhari, Cupertino, CA (US); Devadutta Gude, Mountain View, CA (US); Maria Savarimuthu Rajakannimariyan, Fremont, CA (US)

(72) Inventors: Jack Yu, Cupertino, CA (US); Sachin Chaudhari, Cupertino, CA (US); Devadutta Gude, Mountain View, CA (US); Maria Savarimuthu Rajakannimariyan, Fremont, CA (US)

(73) Assignee: APPCOMPUTING, INC, Sunnyvale, CA (US)

(21) Appl. No.: 14/304,926

(22) Filed: Jun. 14, 2014

Related U.S. Application Data
(63) Continuation-in-part of application No. 13/896,174, filed on May 16, 2013.

(51) Int. Cl. G06Q 10/06

(52) U.S. Cl. CPC G06Q 10/06314
USPC 705/7.24

(57) ABSTRACT

A method for creating a budget is disclosed. The method comprises defining a multi-dimensional data structure comprising a plurality of data containers, each to hold items of budgeting data corresponding to a first fiscal year. Each data container is assigned a unique identifier indicative of the data it is intended to hold, which data is generated by a data module. For a second fiscal year, updating the data structure to include new data containers to hold items of budgeting data corresponding to the second fiscal year; and generating budgeting data to be stored in the new cells by the data module, responsive to a single click.

This application a continuation-in-part of co-pending U.S. patent application Ser. No. 13/896,174, filed on May 16, 2013, titled “Method and System for Generating a Budget that is Scalable in Multiple Dimensions”.

### FIELD

Embodiments of the invention relate to financial planning. In particular, embodiments of the invention relate to budgeting for small to medium sized enterprises.

### BACKGROUND

Budgets are useful in running a business. For example, a budget may be used to calculate (a) the funds needed for labor and/or materials; (b) total start-up costs for a new business; (c) the costs of operations; (d) the revenues necessary to support the business; and (e) a realistic estimate of expected profits.

The inventors have found that most budgets for small businesses are prepared by someone with financial expertise, e.g. a CPA, using a spreadsheet as a tool of choice. To prepare a budget, data such as certain configuration or setup information must be known. Examples of configuration data include the number of departments within an enterprise, the number of fiscal periods for the budget, chart of account mapping information, etc. Once the setup information is captured, expense data must be captured. An example of expense data includes the costs associated with personnel, e.g. employee salary, payroll taxes, and benefits. To actually generate the numbers for a budget, a spreadsheet is setup based on the configuration information and the expense data with complex formula programmed into individual cells to generate the budget numbers.

### SUMMARY OF SOME EMBODIMENTS

This Summary is provided to comply with 37 C.F.R. §1.73, requiring a summary of the present technology briefly indicating the nature and substance of the present technology. It is submitted with the understanding that it will not be used to interpret or limit the scope or meaning of the claims.

Embodiments of the present invention disclose a method for generating a budget that is scalable in multiple dimensions. In one embodiment, the multiple dimensions comprise entity (e.g. in the form of parent company or subsidiary), department cost center, fiscal period, and chart of accounts.

In one embodiment, a user defines the multiple dimensions for a budget; and a multidimensional data structure is created based on the multiple dimensions. The multidimensional data structure may comprise a plurality of locations each to store working data pertaining to a budget. Advantageously, the multidimensional data structure is scalable in any of the multiple dimensions thus providing for a flexible budgeting system.

In one embodiment, a budget calculation engine computes the working data and commits said working data to the correct locations within the multidimensional data structure. The working data may be computed based on user-input raw data; and corporate budget policy data.

Other aspects and example embodiments are provided in the drawings and the detailed description that follows.

### BRIEF DESCRIPTION OF THE FIGURES

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form only in order to avoid obscuring the invention.

The present invention, in accordance with one or more various embodiments, is described in detail with reference to the following figures. The drawings are provided for purposes of illustration only and merely depict exemplary embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 shows a block diagram of a deployment scenario for a budgeting engine, in accordance with one embodiment of the invention.

FIG. 2 shows a block diagram of a Budgeting Engine, in accordance with one embodiment of the invention.

FIG. 3 illustrates a multi-dimensional data structure, in accordance with one embodiment of the invention.

FIG. 4 shows a flowchart for creating a budget, in accordance with one embodiment of the invention.

FIG. 5 shows examples of questions for creating a budget for a new fiscal year, in accordance with one embodiment of the invention.

FIG. 6 shows a high-level block diagram of hardware for implementing a Server Device and/or a Client Device, in accordance with one embodiment of the invention.

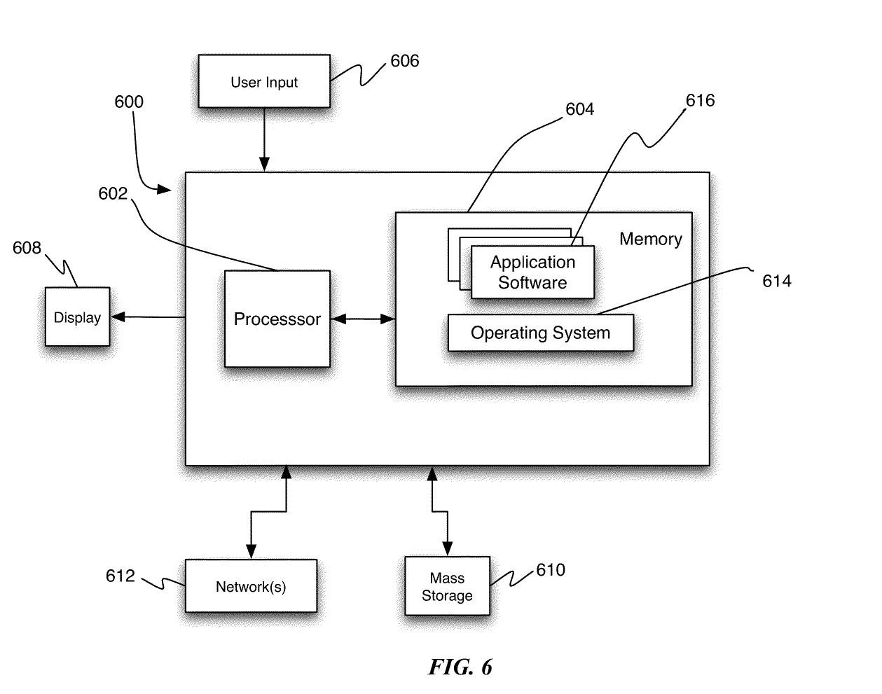

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the invention.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Broadly, embodiments of the present invention disclose a budget creation method and a system for creating a budget based on the budget creation method.

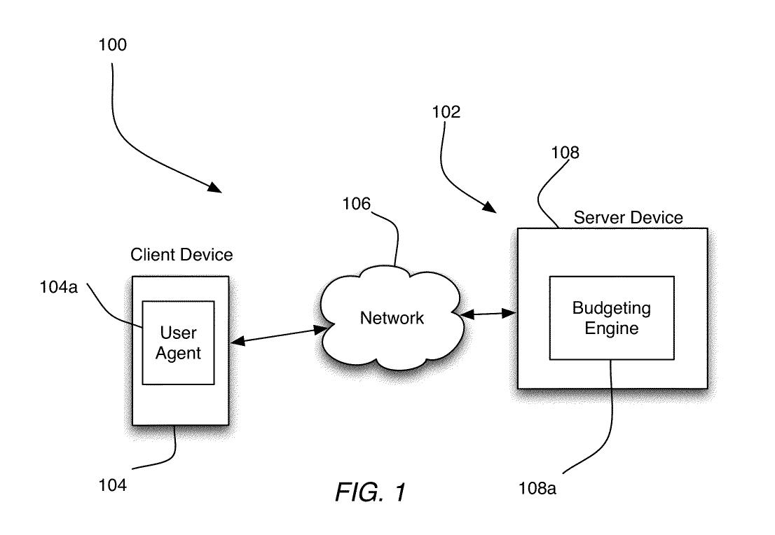

FIG. 1 illustrates a deployment scenario 100 for a budget creation system 102 in accordance with one embodiment. Referring to FIG. 1, the budget creation system 102 is communicatively coupled with a client device 104 via an intermediate network 106.

In one embodiment, the network 106 may comprise the Internet, a wide area network (WAN), metropolitan area network (MAN), local area network (LAN), telephone networks and/or a combination of these and other networks (wired, wireless, public, private or otherwise).

In one embodiment, the budget creation system 102 may comprise a server device 108 that may include a digital data processing apparatus of the type commercially available in the marketplace suitable for operation as described herein, as adapted in accordance with the teachings hereof. Though the server device 108 is typically implemented in a server-class computer, such as a minicomputer, it may also be implemented in a desktop computer, workstation, laptop computer, tablet computer, PDA, mobile phone, car mapping device or other suitable apparatus (again, as adapted in accordance with the teachings hereof).

The server device 108 also comprises central processing, memory, storage and input/output units and other constituent components (not shown) of the type conventional in the art that are configured in accordance with the teachings hereof by a Budgeting Engine 108a.

Although only a single server device 108 is depicted and described here, it will be appreciated that other embodiments may have greater numbers of server devices disposed near and/or far from one another, collocated behind one or more common firewalls or otherwise. Those other servers may differ in architecture and operation from that shown and described here and/or from each other, all consistent with the teachings hereof.

The illustrated client device 104 may include a mobile phone, a laptop computer, a tablet computer, a personal digital assistant (PDA) or other digital data processing apparatus of the type that is commercially available in the marketplace and that is suitable for operation as described herein, all as adapted in accord with the teachings hereof. In one embodiment, the Client Device 102 may be provisioned with a User Agent 104a, e.g. a browser, whereby the Client Device 102 may be able to access the Budgeting Engine 108a.

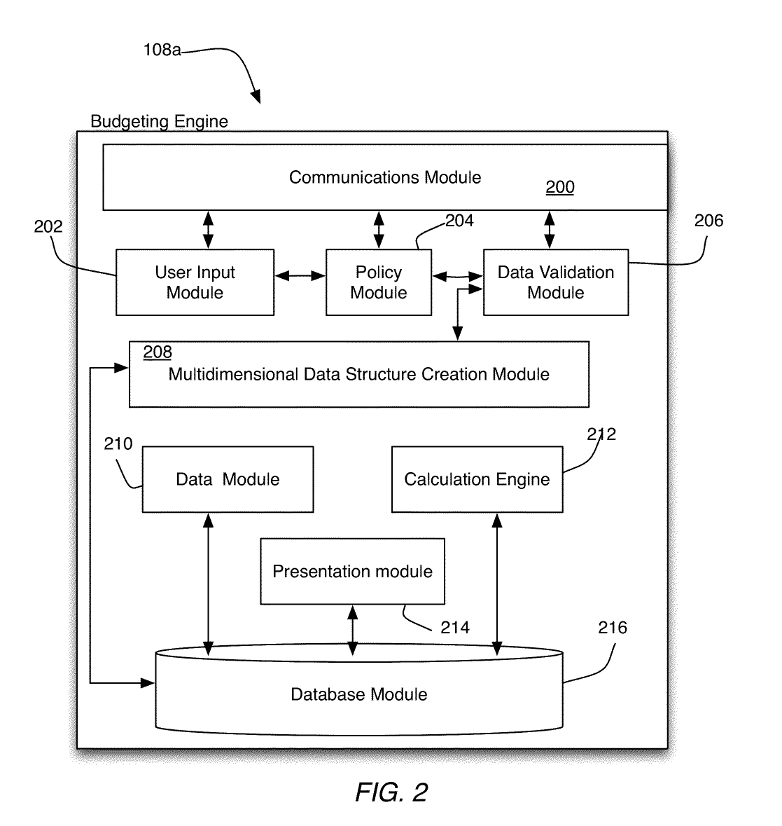

FIG. 2 illustrates the components of the Budgeting Engine 108a, in accordance with one embodiment. As will be seen, the Budgeting Engine 108a comprises a Communications Module 200; a User Input Module 202; a Policy Module 204; a Data Validation Module 206; a Multidimensional Data Structure Creation Module 208; a Data Module 210, a Calculation Engine 212; a Presentation Module 214; and a Database Module 216. The functions and operations of each of the aforesaid components will become apparent from the description below.

In one embodiment, the Communications Module 200 facilitates an exchange of data with the Client Device 102.

In one embodiment, the User Input Module 202 allows a user to input data into the Budgeting Engine 108a. For example, the user may use the User Input Module 102 to input raw data for the Budgeting Engine 108a to transform into a usable budget, as will be described in greater detail below. In one embodiment, the raw data may be input via a simple user interface at the Client Device 104. For example, a user can add an employee, John Smith, in Sales Department, with hire date of Jan. 15, 2013, annual salary of $120,000. Other examples of raw data includes employee hire date, entity, department, work location, fiscal periods, base salary, Chart of Accounts mappings, e.g. for payroll taxes, employee benefits, etc.

In one embodiment, the Policy Module 204 stores corporate budget policy. For example, corporate budget policy may include Chart of Accounts mappings for particular items. Other elements of corporate budget policy may include payroll tax rates, vacation time benefits, workers compensation insurance rates (e.g. 1% of salary), annual salary increase, etc.

In one embodiment, the Data Validation Module 206 may validate the user-input raw data. For example, a number input as a salary may not be a negative amount. Thus, the Data Validation Module 206 may validate that a number that is input as a salary is not negative.

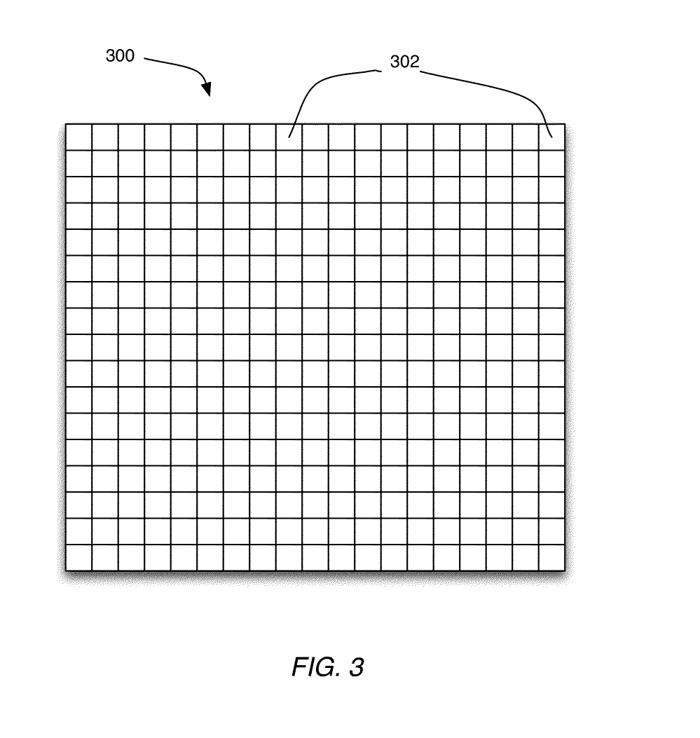

In one embodiment, the Multidimensional Data Structure Creation Module 208 may generate/create a multi-dimensional data structure to store budgeting data. FIG. 3 illustrates a multi-dimensional data structure 300, in accordance with one embodiment. The multi-dimensional data structure 300 comprises a plurality of data containers 302.

Each data container 302 may be defined by four dimensions. In accordance with one embodiment of the invention, these dimensions may include: (i) Entity; (ii) Department; (iii) Fiscal Period; and (iv) Chart of Account. In one embodiment, each of these dimensions is identified with a unique identifier (ID) and each data container 302 is labelled with a unique Cell ID. For example, a data container with Cell ID=100 may be defined by (i) Entity ID=1 (XYZ Corporation); (ii) Department ID=1 (Sales Department); (iii) Fiscal Period ID=1 (January 2013); and (iv) Chart of Account=1 (Salary Expense). Thus, the data container with Cell ID=100 means or implies “January 2013 Salary Expense for Sales Department in XYZ Corporation”. The next data container with Cell ID=101 may be defined by (i) Entity ID=1 (XYZ Corporation); (ii) Department ID=1 (Sales Department); (iii) Fiscal Period ID=2 (February 2013); and (iv) Chart of Account=1 (Salary Expense). Thus, the data container with Cell ID=101 means or implies “February 2013 Salary Expense for Sales Department in XYZ Corporation”. It will be appreciated that the multi-dimensional data structure may define all the necessary data containers with unique Cell IDs for storing budgeting data in its entirety.

In one embodiment, each dimension may have unlimited unique IDs. For example, each of the dimensions may have IDs: 1,2,3,4 . . . , etc. Thus, each dimension can grow indefinitely to accommodate new budgeting data or budgeting data changes as dictated by business requirements. For example, for each new year, the Fiscal Period dimension can grow by adding more Fiscal Period IDs to define the new year periods (12 months, 4 quarters, and one annual); when a business needs to add more departments, the Department dimension can grow by adding more Department IDs; when there is a new subsidiary formed, the Entity dimension can grow by adding a new Entity ID; and when a new expense category is needed, the Chart of Account dimension can grow by adding a new Chart of Account ID. When each of the dimensions grows, the entire data structure will expand with new data containers defined and created by the combinations of unique IDs for each dimension. Since each dimension is independently defined with its own unique IDs, the entire multi-dimensional data structure can grow indefinitely to accommodate all the budgeting data based on business requirements.

Advantageously, because each dimension is independently defined, said dimension can be modified without impacting the data integrity of the data containers. For example, if the Chart of Account ID=1 needs to be changed to have both Salary and Bonus included, the definition for Chart of Account ID=1 may be changed to be “Salary and Bonus Expense”. Thus, the data container with Cell ID=100 is now indicative of a data container for “January 2013 Salary and Bonus Expense for Sales Department in XYZ Corporation”; and the data container with Cell ID=101 is now a data container for “February 2013 Salary and Bonus Expense for Sales Department in XYZ Corporation”; etc. With such a simple change in the dimension definition, all the associated data containers are updated automatically and the data integrity is maintained.

In one embodiment, the multi-dimensional data structure may be version controlled, and may comprise an unlimited number of versions. Each version may include a complete set of data containers and budgeting data stored in each data container. Advantageously, this versioning structure facilitates budgeting analysis based on multiple scenarios. For example, different versions of budget can be created for an upside scenario (where a revenue increase is projected), and a downside scenario (where a revenue decrease is projected). Because these two versions have a similar multi-dimensional data structure, the budgeting data for the two different versions can be compared for each month, each quarter, and for each year on a line by line basis. This makes it easy to see the differences between two different versions of a budget and allows for analysis of detailed assumptions relating to each version. For example, where the revenue projections from what customers have been removed for the downside scenario, and what contributes to more revenue projection in the upside scenario. Such version comparisons can be highly scalable and dynamic. Advantageously, any two versions of a budget may be compared. For e.g. budget vs. actual, upside vs. downside, last quarter vs. this quarter, etc. In one embodiment, all budgeting data edits in different versions are automatically managed. For example, if the upside scenario added 10 more new customers in a new year budget for bigger revenue projection, when the version compare is generated, the system knows where those extra customers were added, and can line up a delta or comparison view side-by-side between the older budget vs. the new budget. In one embodiment, the multi-dimensional data structure may maintain the entire history of budgeting revisions, which provides the necessary data structure for a version compare function between any two versions.

In one embodiment, data calculations may be managed by two components: the Data Module 210 and Calculation Engine 212. The Data Module 210 may calculate interim data; prepare budgeting data based on each Cell ID; and write the budgeting data to corresponding data containers 302.

In one embodiment, the Data Module 210 may comprise pre-defined complex business rules and logic with built-in GAAP/IFRS compliance. Said business rules may be specific to particular departments and applications. For example, business rules for a human resources (HR)-specific Data Module may include a rule that specifies that the monthly salary expense is derived by dividing the annual salary by 12; or a rule that specifies that when salary is increased by x % in the new year budget then the corresponding annual salary must be multiplied by (1+x %). Thus all HR related budgeting data will be managed by the HR-specific Data Module for data modelling, including payroll taxes, employee benefits, accrued compensation liability, etc. Once the Data Module 210 completes the data modelling and calculations, all budgeting data is written to corresponding data containers 302.

In one embodiment, the Calculation Engine 212 may perform final calculations on the budgeting data that was written to the data containers 302 as described above. For ease of reference, the output of the Data Module 210 that is written to the data containers will be referred to herein as “interim budgeting data”, whereas the output of the Calculation Engine 212 will be referred to herein as “final budgeting data”. For example, monthly salary expense and payroll taxes may be calculated by the HR Data Module and will form part of the interim budgeting data. The Calculation Engine 212 may calculate final budgeting data pertaining to an Income Statement, Balance Sheet, and Statement of Cash Flow based on the last mentioned interim budgeting data.

In one embodiment, business logic, data modelling and data calculations are handled automatically by the application/department-specific Data Module 210 and the Calculation Engine 212. Advantageously, a user will not need to manually program, nor modify any of the Data Modules 210 or the Calculation Engine 212. A user will merely need to enter the basic raw data. All the complex data modelling and data calculations will be managed by the Data Module 210 and the Calculation Engine 212, automatically. Since a user has no visibility into the Data Module 210 or the Calculation Engine 210, these components form a “Black Box” from the point of view of the user.

In some embodiments the Data Module 210 may manage complex budgeting data calculation beyond the simple budgeting data calculations such as the employee salary calculation example described above. As an example of a more complex and sophisticated budgeting data calculation, consider the calculation for vacation liability. Based on a vacation policy setting, each employee can earn a certain amount of vacation hours each month. Based on an estimated usage, the Data Module 210 may calculate an un-used vacation hours ending balance for each employee. The Data Module 210 may then calculate an effective salary hourly rate as of the end of the month by taking into consideration any salary increase. The effective salary hourly rate may be used to calculate the dollar value of the un-used vacation hour ending balance for each employee and adjusted for employee termination, where based on the relevant Labor Laws, all the unused vacation hours shall be paid out to employee upon termination, including all the related payroll taxes paid to the government (which are also subject to the annual maximum, and then current effective payroll tax rates).

Example of complex budgeting data modelling and calculations performed by the Data Module 210 may include Sales Projections, revenue, cost of revenue, cash receipts, Bank Loan, Manufacturing Inventory, Fixed Assets and Depreciation, Prepaid Expense, Payable, Deferred Rent, Marketing Programs, etc.

Advantageously, because of the definitions of the four dimensions, it is possible for the Data Module 210 to determine a particular data container from the multi-dimensional data structure to store a particular item of interim budgeting data. In one embodiment, the definitions of the four dimensions serve as specification for how the interim budgeting data should be used for financial analysis, and presented for financial reporting. For example, the data container with Cell ID=100 should be used to store all the budgeting data for January 2013 Salary Expense for Sales Department in XYZ Corporation; and the data container with Cell ID=101 should be used to store all the budgeting data for February 2013 Salary Expense for Sales Department in XYZ Corporation. For financial analysis on Salary Expense for Sales Department in XYZ Corporation, the budgeting data can be easily identified and analysed based on the dimension definition, and therefore, Cell IDs 100, 101 are identified, and the data in those containers can be used for analysis. For financial reporting, based on the dimension definitions, the Cell ID 100 will be presented in Sales Department as Salary Expense for January 2013, and Cell ID 101 will be presented in Sales Department as Salary Expense for February 2013.

Advantageously, with the Budgeting Engine 108a, there is a clear separation between corporate budget policy and data structure. Such a clear separation ensures complete data integrity when either the corporate budget policy or data structure changes. For one example, corporate budget policy defines employee salary expense should be mapped to Chart of Account ID=1 (Salary Expense). Once this is defined, when an employee record is created, all the budgeting data associated with salary expense will be calculated and stored to the data containers with Chart of Account dimension ID=1. For another example, salary expense (as mapped to Chart of Account ID=1) for Sales Department (as defined Department ID=1) in XYZ Corporation (Entity ID=1), for January 2013 (Fiscal Period ID=1) with Hire Date as Jan. 15, 2013, is ((120,000/12)/31)*(31−14)=5,483.87 (⅘ rounded to 2 decimal digits). Such salary expense will be stored to data container Cell ID=100 (as defined by the multi dimension data structure); the same data calculation process will also calculate salary expense for February 2013, as 10,000.00 and this value will be stored in data container Cell ID=101. Thus, the calculation of each item of budgeting data is done and each result stored in the correct data container. The foregoing is a simple example of a calculation performed by the Data Module 210, in one embodiment. In other embodiment, the Data Module 210 may perform calculations based on more complex data, such as sales orders with complex revenue recognition to generate derive final budgeting data in a GAAP (Generally Accepted Accounting Principles)/IFRS (International Financial Reporting Standards) compliant format.

In one embodiment, the Calculation Engine 212 may load the interim budgeting data prepared by Data Module 210 from the data containers 302 and maps inter-dependency relationships in the interim budgeting data based on pre-defined business logic and the cell ID associated with the data containers 302. The inter-dependency relationships may specify calculation dependencies and hence an order in which the calculations are to be performed. For example, Total Sales department expense for January 2013 needs to add up all the budgeting data from all the chart of accounts for the Sales department for January 2013, including, for example, Salary, Payroll Tax, Benefits, Travel Expenses, etc.; then such Total Sales department expense for January 2012 will be reported in the Income Statement, and add up to the Net Income for January 2013; such Net Income will then be reported in the Balance Sheet as Current Period Profit; and it will be rolled up to the cash balance for January 2013; then the Cash Flow Statement will be calculated based on the Balance Sheet. All these inter-dependency data calculations may be managed by the Calculation Engine 212 automatically.

The clear separation of user raw data input, corporate budget policy, and data calculation (as a “Black Box”) makes it possible to manage the budget revision automatically without user having to make any adjustments to the business logic and data calculation modelling. For example, if user wants to change the employee hire date, such a change can be entered in an Employee Record for the employee in a “Hire Date” field. Then, the Data Module 210 will take that raw data input, automatically re-calculate all the budgeting data, update all the data containers, and present the updated financial numbers in the final budgeting financial statements. In a further example, if a user wants to modify the annual salary increase rate from 5% to 8%, such annual salary increase percentage can be entered via corporate budget policy, HR Settings. Then, the data calculation engine will apply such new rate to all the HR Employees, automatically re-calculate all the budgeting data, update all the data containers, and present the updated financial numbers in the final budgeting financial statements. This makes it very easy for user to modify budgeting assumptions without having to make any adjustments to the business logic and data calculation modelling. This also makes it possible for business managers, who have no sophisticate accounting/finance knowledge, to make budget revisions and analysis independently without any help from CPAs or financial experts.

In one embodiment, once the budgeting data is calculated and stored in the data containers 302 in the multi-dimensional data structure 300, the Presentation Module 212 prepares financial statements based on the built-in intelligence of the four dimensions associated with each data container 302. In one embodiment, the financial statements are compliant with GAAP/IFRS requirements, and may include pre-defined financial statements. The latter may include a Balance Sheet, an Income Statement, a Statement of Cash Flow together with all tabs and exhibits for additional financial data. Based on the multi-dimensional data structure 300, the Presentation Module 212 may define all the Fiscal Periods as columns and Chart of Accounts as rows in each financial statement. For example, data container Cell ID 100 is for January 2013 Salary Expense for Sales Department in XYZ Corporation and may contain a value of “5,483.87”. The Presentation Module 212 knows to present the value “5,483.87” in the Sales Department tab, in column January 2013, in row of Chart of Account ID 1, Salary Expense based on the Cell ID associated with the value “5,483.87”. Thus, the Presentation Module 212 maps the data in each of the data containers 302 to its correct location in each of the financial statements and delivers said financial statements in a GAAP/IFRS compliant format to a user via the Client Device 104.

Advantageously, embodiments of the present invention disclose a clear separation of the following processes in creating a budget: (i) user-input of raw data; (ii) data validation; (iii) input of corporate budget policy; (iv) data calculation via a data module and a calculation engine; (v) data storage in data containers with a multi-dimensional data structure; and (vi) financial presentation. Such separation of processes can allow a very simple user interface for a user to enter just the raw data without needing to create or maintain any complex rules and formula for the data validation and data calculations. The user can then see the final budgeting data presented in GAAP/IFRS compliant financial statements. The Budgeting Engine 108a will take care of all the compliance with GAAP, IFRS, labor laws, tax laws in the data validation process and data calculation process in the calculation engine, and store all the final budgeting data in the data containers of the multi-dimensional data structure. Such final budgeting data are ready for financial presentation via the Presentation Module 214.

Advantageously, the Budgeting Engine 108a allows users who do not have to have any sophisticated accounting or financial knowledge to create a quality budget.

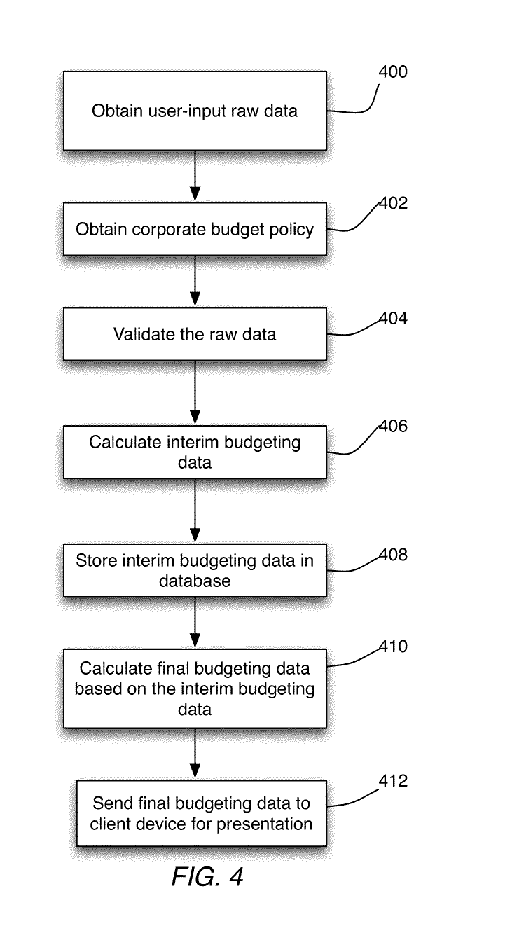

Referring now to FIG. 4 of the drawings, there is shown a flowchart of the overall budgeting process described above. Said process includes the following processing blocks:

Block 400 where user-input raw data is obtained

Block 402 where corporate budget policy is defined by a user

Block 404 where the raw data is validated

Block 406 where interim budgeting data is calculated

Block 408 where the interim budgeting data is stored in a database

Block 410 where the final budgeting data is calculated based on the interim budgeting data and stored in a database

Block 412 where the final budgeting data is sent to a Client Device 104 for presentation.

Process for Budgeting for a New Fiscal Year

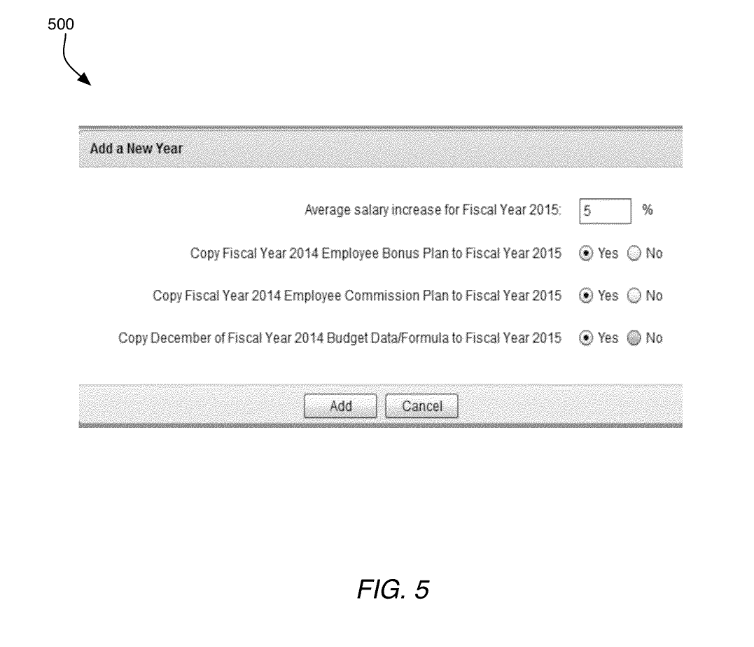

Advantageously, the techniques disclosed herein for creating a budget may be used to facilitate rapid extension of the budget to cover a new fiscal year, as will now be explained. In one embodiment, to create a budget for a new fiscal year, a user is asked a few questions to determine changes for the new fiscal year. Examples of the types of questions that may be asked are provided in the screenshot 500 shown in FIG. 5. Once answers to the questions are received, a single click of a mouse will result in generation of the budget data for the new fiscal year. In terms of system steps, the single click causes the system to create data containers in the multi-dimensional data structure, each to hold items of budgeting data corresponding to the new fiscal year. Then the data for the new fiscal year is generated and stored in the correct data cells in similar fashion to what has already been described. Thus, the system automatically (a) prepares the multi-dimensional data structure for the new year including container to hold all new months, and quarters, (b) populates all labels and system formulas, calculates all data for the new year by the data module, and (c) generates a Balance Sheet, Income Statement, and Statement of Cash Flow, each for the new fiscal year.

As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. After reading this description, it will become apparent to a person skilled in the relevant art how to implement the invention using other computing modules or architectures.

The devices 102, 104 might include, for example, one or more processors, controllers, control modules, or other processing devices. Modules might be implemented using a general-purpose or special-purpose processing engine such as, for example, a microprocessor, controller, or other control logic. The modules may be connected to a bus, although any communication medium can be used to facilitate interaction with other components of computing modules or to communicate externally.

The devices 102, 104 might also include one or more memory modules, simply referred to herein as main memory. For example, preferably random access memory (RAM) or other dynamic memory might be used for storing information and instructions to be executed by processor. Main memory might also be used for storing temporary variables or other intermediate information during execution of instructions to be executed by processor. Computing module might likewise include a read only memory (“ROM”) or other static storage device coupled to bus for storing static information and instructions for processor.

The devices 102, 104 might also include one or more various forms of information storage mechanisms, which might include, for example, a hard disk, a floppy disk, magnetic tape, cartridge, optical disk, a CD, DVD or Blu-ray, or other fixed or removable medium that is read by, written to or accessed by media drive. As these examples illustrate, the storage media can include a computer usable storage medium having stored therein computer software or data.

In alternative embodiments, the information storage mechanism might include other similar instrumentalities for allowing computer programs or other instructions or data to be loaded into computing module. Such instrumentalities might include, for example, a fixed or removable storage unit and an interface. Examples of such storage units and interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module.

The devices 102, 104 might also include a communications interface 305 such as an Ethernet, network interface card, Wi-Fi, IEEE 802.XX or other interface), or other communications interface. Data transferred via communications interface might typically be carried on signals, which can be electronic, electromagnetic (which includes optical) or other signals capable of being exchanged by a given communications interface. These signals might be provided to communications interface via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), flash drives among others.

FIG. 5 shows an example of hardware 500 that may be used to implement the any of the devices 104,108. The hardware 500 typically includes at least one processor 502 coupled to a memory 504. The processor 502 may represent one or more processors (e.g., microprocessors), and the memory 504 may represent random access memory (RAM) devices comprising a main storage of the hardware 500, as well as any supplemental levels of memory e.g., cache memories, non-volatile or back-up memories (e.g. programmable or flash memories), read-only memories, etc. In addition, the memory 504 may be considered to include memory storage physically located elsewhere in the hardware 500, e.g. any cache memory in the processor 502, as well as any storage capacity used as a virtual memory, e.g., as stored on a mass storage device 510.

The hardware 500 also typically receives a number of inputs and outputs for communicating information externally. For interface with a user or operator, the hardware 500 may include one or more user input devices 506 (e.g., a keyboard, a mouse, a scanner etc.) and a display 508 (e.g., a Liquid Crystal Display (LCD) panel). For additional storage, the hardware 500 may also include one or more mass storage devices 510, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 500 may include an interface with one or more networks 512 (e.g., a local area network (LAN), a wide area network (WAN), a wireless network, and/or the Internet among others) to permit the communication of information with other computers coupled to the networks. It should be appreciated that the hardware 500 typically includes suitable analog and/or digital interfaces between the processor 502 and each of the components 504, 506, 508 and 512 as is well known in the art.

The hardware 500 operates under the control of an operating system 514, and executes various computer software applications, components, programs, objects, modules, etc. indicated collectively by reference numeral 516 to perform the techniques described above

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), flash drives among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

“Example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration. Also, techniques, devices, subsystems and methods described and illustrated in the various embodiments as discrete or separate may be combined or integrated with other systems, modules, techniques, or methods without departing from the scope of the present technology. Other items shown or discussed as directly coupled or communicating with each other may be coupled through some interface or device, such that the items may no longer be considered directly coupled with each other but may still be indirectly coupled and in communication, whether electrically, mechanically, or otherwise, with one another. Other examples of changes, substitutions, and alterations ascertainable by one skilled in the art, upon or subsequent to studying the exemplary embodiments disclosed herein, may be made without departing from the spirit and scope of the present technology.

Various embodiments of the present disclosure, as discussed above, may be practiced with steps and/or operations in a different order, and/or with hardware elements in configurations which are different than those which are disclosed. Therefore, although the technology has been described based upon these exemplary embodiments, it is noted that certain modifications, variations, and alternative constructions may be apparent and well within the spirit and scope of the technology. Although various exemplary embodiments of the present technology are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method for creating a budget, comprising:
defining a multi-dimensional data structure comprising a plurality of data containers, each to hold an item of budgeting data corresponding to a first fiscal year; wherein each data container comprises a unique identifier indicative of the item of budgeting data it is intended to hold; and wherein said unique identifier is based on a unique combination of multiple dimensions associated with the budget;
calculating by a data module, items of interim budgeting data for the first fiscal year based on corporate budget policy and user-input raw data;
storing each item of interim budgeting data for the first fiscal year in a container of the multi-dimensional data structure wherein the container is selected based on matching the item of interim budgeting data to the container's identifier; and
executing a process to create a budget for a second fiscal year subsequent to the first, comprising:
updating the multi-dimensional data structure by adding new data containers thereto, each of said new data containers to hold an item of budgeting data corresponding to the second fiscal year;
calculating by the data module, items of interim budgeting data for the second fiscal year based on corporate budget policy and user-input raw data; and
storing each item of interim budgeting data for the second fiscal year in a container of the multi-dimensional data structure wherein the container is selected based on matching the item of interim budgeting data to the container's identifier.

2. The method of claim 1, wherein each of the multiple dimensions is selected from the group consisting of an entity, a department, a fiscal period, and a chart of accounts.

3. The method of claim 2, wherein the multi-dimensional data structure comprises a plurality of versions.

4. The method of claim 3, wherein each dimension comprises unique values and is infinitely scalable, each unique value having a unique identifier.

5. The method of claim 4, wherein each dimension is independent of each other dimension.

6. The method of claim 5, wherein the unique identifier for each data container comprises a concatenation of the unique identifiers for the values associated with each dimension at a location for the data container within the multi-dimensional data structure.

7. The method of claim 1, further comprising retrieving by a calculation engine, items of the interim budgeting data from the multi-dimensional data structure based on the unique identifiers associated with the data container within the multi-dimensional data structure, calculating items of final budgeting data based on the items of interim budgeting data and inter-dependency relationships between the items of interim budgeting data, and storing each item of final budgeting data in a container of the multi-dimensional data structure wherein the container is selected based on matching the item of interim budgeting data to the container's identifier.

8. The method of claim 7, further comprising retrieving by a presentation module, items of final budgeting data from the multi-dimensional data structure based on the unique identifiers associated with the data container within the multi-dimensional data structure; wherein the items of final budgeting data corresponds to a pre-defined financial statement; and sending the retrieved budgeting data to a client device for rendering thereon.

9. The method of claim 1, wherein the data module is provisioned with at least one of calculation rules and business logic to calculate the items of interim budgeting data, said data module being separate from the multi-dimensional data structure.

10. The method of claim 1, wherein executing the process to create a budget for the second fiscal year subsequent to the first is responsive to a single click to create the budget for the second fiscal year.

11. A system for creating a budget, comprising:
a processor; and
a memory coupled to the processor, the memory storing instructions which when executed by the processor causes the system to perform a method for creating a budget, comprising
defining a multi-dimensional data structure comprising a plurality of data containers, each to hold an item of budgeting data corresponding to a first fiscal year; wherein each data container comprises a unique identifier indicative of the item of budgeting data it is intended to hold; and wherein said unique identifier is based on a unique combination of multiple dimensions associated with the budget;
calculating by a data module, items of interim budgeting data for the first fiscal year based on corporate budget policy and user-input raw data;
storing each item of interim budgeting data for the first fiscal year in a container of the multi-dimensional data structure wherein the container is selected based on matching the item of interim budgeting data to the container's identifier; and
executing a process to create a budget for a second fiscal year subsequent to the first, comprising:
updating the multi-dimensional data structure by adding new data containers thereto, each of said new data containers to hold an item of budgeting data corresponding to the second fiscal year;
calculating by the data module, items of interim budgeting data for the second fiscal year based on corporate budget policy and user-input raw data; and
storing each item of interim budgeting data for the second fiscal year in a container of the multi-dimensional data structure wherein the container is selected based on matching the item of interim budgeting data to the container's identifier.

12. The system of claim 12, wherein each of the multiple dimensions is selected from the group consisting of an entity, a department, a fiscal period, and a chart of accounts.

13. The system of claim 13, wherein the multi-dimensional data structure comprises a plurality of versions.

14. The system of claim 13, wherein each dimension comprises unique values and is infinitely scalable, each unique value having a unique identifier.

15. The system of claim 14, wherein each dimension is independent of each other dimension.

16. The system of claim 15, wherein the unique identifier for each data container comprises a concatenation of the unique identifiers for the values associated with each dimension at a location for the data container within the multi-dimensional data structure.

17. The system of claim 11, wherein the method further comprises retrieving by a calculation engine, items of the interim budgeting data from the multi-dimensional data structure based on the unique identifiers associated with the data container within the multi-dimensional data structure, calculating items of final budgeting data based on the items of interim budgeting data and inter-dependency relationships between the items of interim budgeting data, and storing each item of final budgeting data in a container of the multi-dimensional data structure wherein the container is selected based on matching the item of interim budgeting data to the container's identifier.

18. The system of claim 17, wherein the method further comprises retrieving by a presentation module, items of final budgeting data from the multi-dimensional data structure based on the unique identifiers associated with the data container within the multi-dimensional data structure; wherein the items of final budgeting data corresponds to a pre-defined financial statement; and sending the retrieved budgeting data to a client device for rendering thereon.

19. The system of claim 11, wherein the data module is provisioned with at least one of calculation logic and business rules to calculate the budgeting data, said data module being separate from the multi-dimensional data structure.

20. The system of claim 19, wherein executing the process to create a budget for the second fiscal year subsequent to the first is responsive to a single click to create the budget for the second fiscal year.

21. A computer-readable medium having stored thereon a sequence of instructions which executed by a system, causes the system to perform a method for creating a budget, comprising:
defining a multi-dimensional data structure comprising a plurality of data containers, each to hold an item of budgeting data corresponding to a first fiscal year; wherein each data container comprises a unique identifier indicative of the item of budgeting data it is intended to hold; and wherein said unique identifier is based on a unique combination of multiple dimensions associated with the budget;
calculating by a data module, items of interim budgeting data for the first fiscal year based on corporate budget policy and user-input raw data;
storing each item of interim budgeting data for the first fiscal year in a container of the multi-dimensional data structure wherein the container is selected based on matching the item of interim budgeting data to the container's identifier; and
executing a process to create a budget for a second fiscal year subsequent to the first, comprising:
updating the multi-dimensional data structure by adding new data containers thereto, each of said new data containers to hold an item of budgeting data corresponding to the second fiscal year;
calculating by the data module, items of interim budgeting data for the second fiscal year based on corporate budget policy and user-input raw data; and
storing each item of interim budgeting data for the second fiscal year in a container of the multi-dimensional data structure wherein the container is selected based on matching the item of interim budgeting data to the container's identifier.

22. The computer-readable medium of claim 21, wherein each of the multiple dimensions is selected from the group consisting of an entity, a department, a fiscal period, a chart of accounts.

23. The computer-readable medium of claim 18, wherein executing the process to create a budget for the second fiscal year subsequent to the first is responsive to a single click to create the budget for the second fiscal year.
